(19) United States
(12) Patent Application Publication
(10) Pub. No.: US 2009/0056178 A1
(43) Pub. Date: Mar. 5, 2009

(54) DISPLAY MARKER BANDS

(75) Inventor: Deborah K. Cooper, Inver Grove Heights, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: BANDELZ, INC., Inver Grove Heights, MN (US)

(21) Appl. No.: 12/198,470

(22) Filed: Aug. 26, 2008

Related U.S. Application Data
(60) Provisional application No. 60/968,971, filed on Aug. 30, 2007.

(51) Int. Cl. G09F 3/00

(52) U.S. Cl. 40/299.01; 29/896.41

(57) ABSTRACT

A display marker band is adapted for reversible attachment to a relatively flexible closed-loop member, which loop member has an approximately rectangular cross-section defined by a relaxed width and a relaxed thickness and is adapted to slide over an appendage of a body for mounting thereon. The marker band includes a rigid display sidewall, which is bounded by first and second perimeter edges and has a mark formed therein, and, at least when attached to the loop member, includes flap sidewalls that extend opposite an interior face of the display sidewall and are each bounded by the first and second perimeter edges and a convexly curved perimeter edge. According to some methods, the flexible closed-loop member may be positioned between the display sidewall and the opposing flap sidewalls without deforming the marker band.

### PRIORITY CLAIM

The present application claims priority to provisional application Ser. No. 60/968,971 filed on Aug. 30, 2007, which is hereby incorporated, by reference, in its entirety.

### BACKGROUND

Flexible closed-loop members, for example, bands, such as rings and bracelets, or shoe straps, may be mounted upon appendages of a body to adorn the body. These members can provide a substrate on which to display one or more communicative, and/or decorative, marks, for example, symbols and/or words and/or numbers. The present invention pertains to display marker bands and the reversible attachment thereof to such members.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIG. 1A is a front plan view of a display marker band, according to some embodiments of the present invention.

FIG. 1B is a rear plan view of the marker band of FIG. 1A.

FIG. 1C is a perspective view, wherein hidden lines are shown, of the marker band of FIG. 1A.

FIG. 2 is a schematic describing a step in a method for reversibly attaching the marker band to a flexible closed-loop member.

FIG. 3A is a front plan view of a display marker band, according to some other embodiments of the present invention.

FIG. 3B is a perspective view, wherein hidden lines are shown, of the marker band of FIG. 3A.

FIG. 4 is a perspective view of yet another embodiment of a display marker band, wherein the marker band is attached to the flexible closed-loop member.

FIG. 5A is a perspective view of a display marker band, according to some alternate embodiments.

FIG. 5B is an end view of the marker band of FIG. 5A.

FIG. 6A is a rear plan view of a display marker band, according to yet further additional embodiments.

FIG. 6B is an end view of the marker band of FIG. 6A.

FIGS. 7A-E are schematics describing an exemplary progressive stamping manufacturing method, which may be used to make display marker bands of the present invention.

### DETAILED DESCRIPTION

The following detailed description is exemplary in nature and is not intended to limit the scope, applicability, or configuration of the invention in any way. Rather, the following description provides practical illustrations for implementing exemplary embodiments. Examples of constructions, materials, dimensions, and manufacturing processes are provided for selected elements, as examples, and all other elements employ that which is known to those of skill in the field of the invention. Utilizing the teaching provided herein, those skilled in the art will recognize that many of the examples have suitable alternatives that can be utilized.

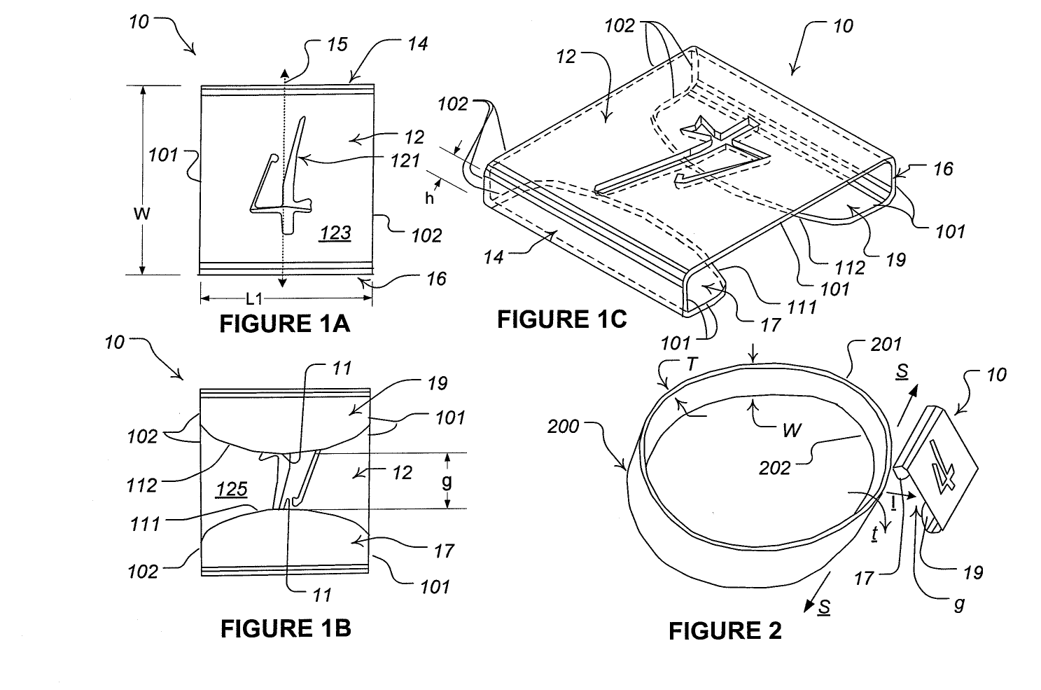

FIG. 1A is a front plan view of a display marker band 10, according to some embodiments of the present invention; FIG. 1B is a rear plan view of marker band 10; and FIG. 1C is a perspective view, wherein hidden lines are shown, of marker band 10. FIGS. 1A-C illustrate marker band 10 including a display sidewall 12, first and second end sidewalls 14, 16, which extend opposite one another and approximately perpendicular to display sidewall 12, and first and second flap sidewalls 17, 19, each of which extend approximately perpendicular to the corresponding end sidewall 14, 16, and opposite display sidewall 12. First and second perimeter edges 101, 102 of marker band 10 are shown bounding display sidewall 12, end sidewalls 14, 16 and flap sidewalls 17, 19; and, although perimeter edges 101, 102 are shown being substantially straight and parallel to one another, in alternate embodiments, these edges may be curved and/or oriented with respect to one another in a different manner. FIGS. 1B-C further illustrate first and second convexly curved perimeter edges 111, 112 bounding first and second flap sidewalls 17, 19, respectively, along with portions of the first and second perimeter edges, and each of first and second convexly curved perimeter edges 111, 112 defined by an arc, which extends from first perimeter edge 101 to second perimeter edge 102, such that an apex 11 of each arc is approximately centered between first and second perimeter edges 101, 102.

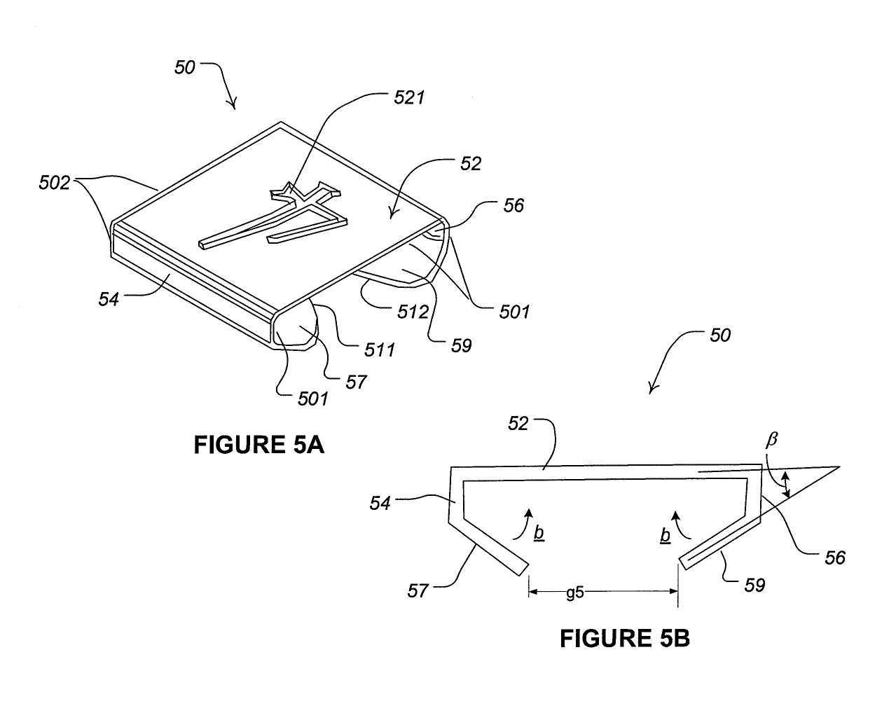

According to some preferred embodiments of the present invention, each of sidewalls 12, 14, 16, 17, 19 is rigid, and extends in rigid relation to one another. According to the illustrated embodiment, first and second flap sidewalls 17, 19 are approximately coplanar. Alternate embodiments of marker bands, wherein the flap sidewalls have a different orientation, will be described below, in conjunction with FIGS. 5A-B and 6A-B. Marker band 10 may be formed from sheet metal, for example, hot or cold rolled steel, or aluminum. According to an exemplary embodiment, marker band 10 is formed from 302 stainless steel sheet metal having a thickness of approximately 0.012 inch.

FIGS. 1A-C further illustrate a mark 121 formed in display sidewall 12 and displayed along an exterior face 123 of display sidewall 12. According to the illustrated embodiment, mark 121 is formed by an aperture extending through display sidewall 12 to an interior face 125 thereof, for example, having been formed by either stamping/punching or laser cutting; however, according to alternate embodiments, mark 12 may be a raised and/or a recessed portion of exterior face 123 of display sidewall 12, for example, formed by embossing or debossing, respectively. Alternate methods for forming mark 121 and/or for creating a particular surface finish along marker band 10 include, without limitation, steel or other types of stenciling, plating, silk-screening, anodizing, painting and ball burnishing. With further reference to FIG. 1A, an upright orientation of mark 121, which is formed as the number “4”, is defined by an axis 15 that is aligned approximately parallel with an extent of first and second perimeter edges 101, 102, which bound display sidewall 12.

FIG. 2 is a schematic describing a step in a method for reversibly attaching marker band 10 to a flexible closed-loop member 200. Although flexible closed-loop member 200 is shown in the form of a generally circular loop, for example, as embodied by rings or bracelets, it should be understood that the closed-loop may be of any geometry. Furthermore, flexible closed-loop members, to which marker bands of the present invention may be reversibly attached, also encompass a strap-like member joined to another structure, for example, a strap joined to a sole of a shoe, such as a thong strap of a flip-flop type shoe. Examples of materials from which these flexible members may be formed, include, without limitation, silicone rubber, polyurethane and leather. FIGS. 2 and 1B illustrate an opening between convexly curved perimeter edges 111, 112 that bound flap sidewalls 17, 19, which opening allows for attachment of marker band 10 to flexible closed-loop member 200, via insertion, per arrow I, of a deformed portion of loop member 200, without the need to deform marker band 10, and likewise for detachment of marker band 10 from member 200. FIG. 2 further illustrates marker band 10 being held in an orientation such that flap sidewalls 17, 19 face flexible loop member 200, and flexible loop member 200 being deformed, for insertion, per arrow I, between flap sidewalls 17, 19.

With reference back to FIGS. 1A and 1C, it may be appreciated that a width w of marker band 10, which is defined between first and second end sidewalls 14, 16, is approximately equal to or slightly greater than a width W of relaxed closed-loop flexible member 200, and a height h of each end sidewall 14, 16 is approximately equal to or slightly greater than a thickness T of relaxed loop member 200. Thus, when an outer surface of member 200 is against interior face 125 of marker band 10, and an inner surface of member 200 is against flap sidewalls 14, 16, the attached marker band fits relatively snugly around the approximately rectangular cross-section of flexible closed-loop member 200. According to one exemplary embodiment, both a length L1 and width w of marker band 10 are approximately one half of an inch, and height h of marker band 10 is between approximately 0.09 inch and approximately 0.15 inch.

With further reference to FIG. 1B, it may be appreciated that convexly curved perimeter edges 111, 112 provide a relatively smooth opening, which tapers on either side of apex 11 of each of the arcs, which define curved edges 111, 112; this tapering facilitates insertion of a deformed portion of loop member 200 into a space bounded by the sidewalls 12, 14, 16, 17, 19, while a gap g, which is defined between apexes 11 (a minimum distance between the convexly curved perimeter edges), is narrow enough to prevent the marker band from detaching from flexible closed-loop member 200, unless member 200 is deformed. According to some embodiments, gap g is greater than relaxed thickness T of loop member 200, so that by simply twisting, per arrow t, a portion of the member may be inserted between flap sidewalls 17, 19. According to some alternate embodiments, gap g is only greater than a necked-down portion of member 200, for example, being stretched, per arrows S, so that member 200 must be stretched for insertion in between flaps 17, 19.

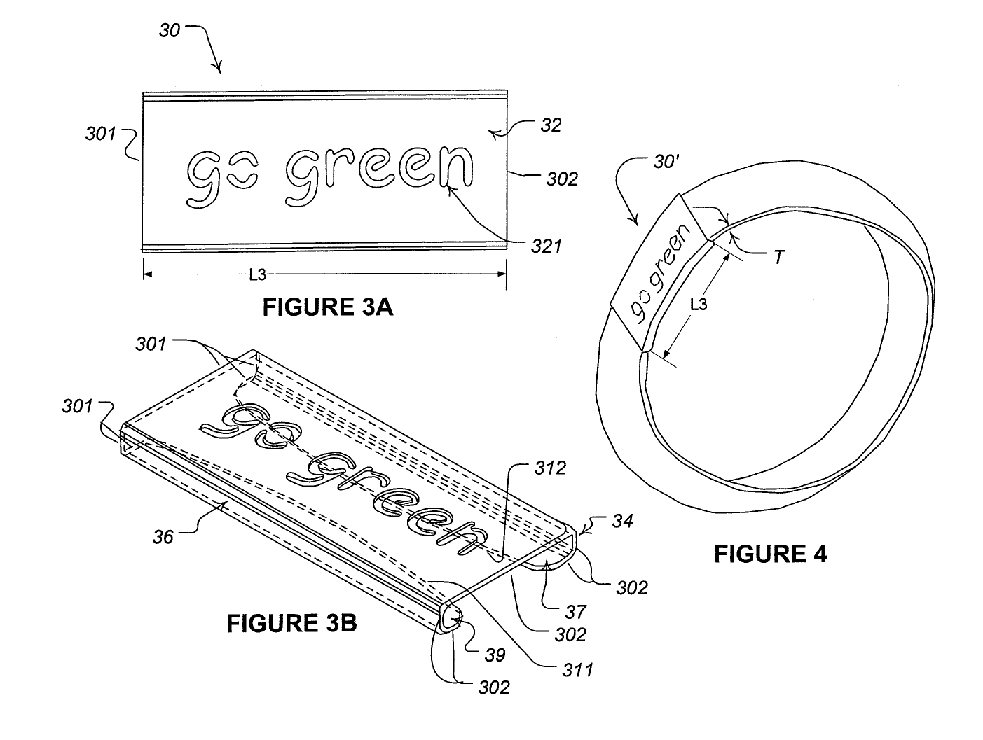

FIG. 3A is a front plan view of another display marker band 30, according to some other embodiments of the present invention; and FIG. 3B is a perspective view, wherein hidden lines are shown, of marker band 30. FIGS. 3A-B illustrate marker band 30 including a display sidewall 32, first and second end sidewalls 34, 36, and first and second flap sidewalls 37, 39, similar to marker band 10. FIGS. 3A-B further illustrate a mark 321, which is formed by a plurality of apertures extending through display sidewall 32, that are shaped to form letters spelling out the words “go green”. Like marker band 10, an upright orientation of the “go green” mark 321 is approximately aligned parallel with first and second perimeter edges 301, 302, that bound display sidewall 32, and mark 321 may alternately be embossed or debossed within the display sidewall, or formed by any other method known to those skilled in the art. It should be noted that other types of marks formed in marker bands of the present invention may be any type of symbol or picture, for example, a company or promotional logo or a school or team mascot.

With further reference to FIGS. 3A-B, it may be appreciated that, although a length L3 of marker band 30 is greater than length L1 of marker band 10, in order to accommodate the words “go green”, each of sidewalls 32, 34, 36, 37, 39 for marker band 30 are oriented and bounded by perimeter edges 301, 302 in a configuration very similar to marker band 10. Likewise, marker band 30 is preferably formed from sheet metal as previously described, such that each of the sidewalls thereof are relatively rigid and extend in rigid relation to one another. According to an exemplary embodiment, marker band 30 has a width and height similar to those of marker band 10, and length L3 is approximately 1.25 inches.

Turning now to FIG. 4, an alternate embodiment of a longer marker band is shown. FIG. 3C illustrates a marker band 30′ having a curved contour, along length L3 (as opposed to the previously shown flat contour of marker band 30). According to the illustrated embodiment, the curved contour approximately matches a relaxed contour of flexible loop member 200 to which marker band 30′ is attached.

FIG. 5A is a perspective view of a display marker band 50, according to some alternate embodiments; and FIG. 5B is an end view of marker band 50. FIGS. 5A-B illustrate display marker band 50 including first and second perimeter edges 501, 502 bounding both a display sidewall 52 and first and second end sidewalls 54, 56, and convexly curved perimeter edges 511, 512 bounding first and second flap sidewalls 57, 59, respectively, similar to marker bands 10, 30. FIGS. 5A-B further illustrate first and second flap sidewalls 57, 59 of marker band 50 extending at an acute angle A, which is between 90 degrees and 0 degrees, with respect to display sidewall 52. Marker band 50 may be formed from sheet metal, for example, according to examples previously cited for marker bands 10, 30, and further includes a mark 521, which is formed as an aperture through display sidewall 52.

According to some embodiments, after inserting flexible closed-loop member 200 into an opening between convexly curved perimeter edges 511, 512, for example, as described for marker band 10, in conjunction with FIG. 2, first and second flap sidewalls 57, 59 may be bent around the inserted member, for example, per arrows b of FIG. 5B, so that sidewalls 52, 54, 56, 57, 59 of marker band 50 fit relatively snugly around the approximately rectangular cross-section of flexible closed-loop member 200. According to preferred embodiments, flap sidewalls 57, 59 are relatively rigid and extend in relatively rigid relation to end sidewalls 54, 56 before and after bending. Prior to bending, as shown in FIG. 5B, a gap g5, which is located between an apex of each arc that defines each convexly curved perimeter edge 511, 512 bounding flap sidewalls 57, 59, respectively, may be less than, or approximately equal to thickness T of member 200, according to some embodiments, or greater than this thickness, according to other embodiments.

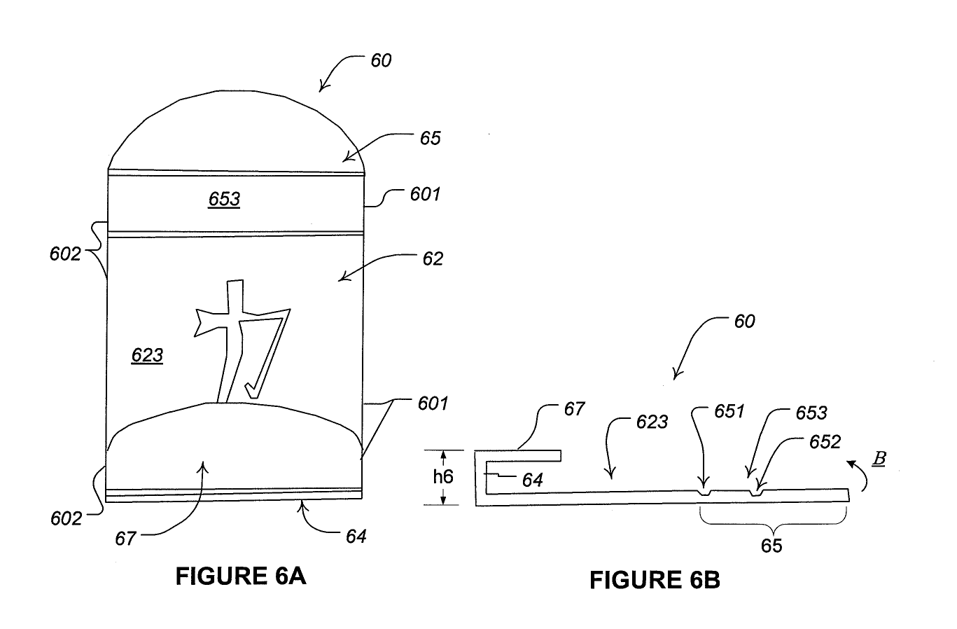

FIG. 6A is a rear plan view of a marker band 60 according to yet further additional embodiments; and FIG. 6B is an end view of marker band 60. FIGS. 6A-B illustrate marker band 60 including first and second perimeter edges 601, 602 bounding a display sidewall 62, an end sidewall 64 and a deformable sidewall 65, a first convexly curved perimeter edge 611 bounding deformable sidewall 65, and a second convexly curved perimeter edge 612 bounding a flap sidewall 67. Similar to marker bands 10, 30, end sidewall 64 is relatively rigid and extends approximately perpendicular and in relatively rigid relation to display sidewall 62, and flap sidewall 67 is relatively rigid and extends approximately perpendicular to and in relatively rigid relation to end sidewall 64. FIGS. 6A-B further illustrate an interior face 653 of deformable sidewall 65, extending approximately coplanar with an interior face 623 of display sidewall 62, and first and second notches 651, 652 formed in deformable sidewall 65. Marker band 60 may be formed from sheet metal, for example, according to examples previously cited.

According to the illustrated embodiment, first and second notches 651, 652, which are spaced apart from one another, for example, at a distance corresponding to a height h6 of end sidewall 64, facilitate bending, per arrow B, by a user who seeks to attach marker band 60 to a flexible closed-loop member, for example, member 200. With reference back to FIG. 2, marker band 60 may be oriented as is illustrated for marker band 10, with respect to flexible closed-loop member 200, for insertion of member 200, however the twisting and/or stretching of member 200 may not be necessary to attach marker band 60 thereto. For example, one may slide a first edge 201 of member 200 between flap sidewall 67 and display sidewall 62 of marker band 60, and then bend deformable sidewall 65 around member 200, such that member 200 fits snugly within sidewalls 62, 64, 65, 67 of marker band 60. According to preferred embodiments, deformable sidewall 65 extends in relatively rigid relation to display sidewall 62 prior to bending and, subsequent to bending, sidewall 65 will comprise another end sidewall and flap sidewall that also extend in relatively rigid relation with respect to the other sidewalls 62, 64, 67.

It should be noted that, although marker bands 50, 60 are deformed following insertion of flexible closed-loop member 200, in order to secure the inserted member within the space bounded by the sidewalls thereof, each marker band 50, 50 may be detached from member 200 by deforming member 200 as previously described, for example, via stretching and/or twisting, without deforming each marker band 50, 60 again. Furthermore, marker bands 50, 60 may be re-attached to the same or a different flexible closed-loop member without need to deform the marker bands again, for example, via the method described above, in conjunction with FIG. 2.

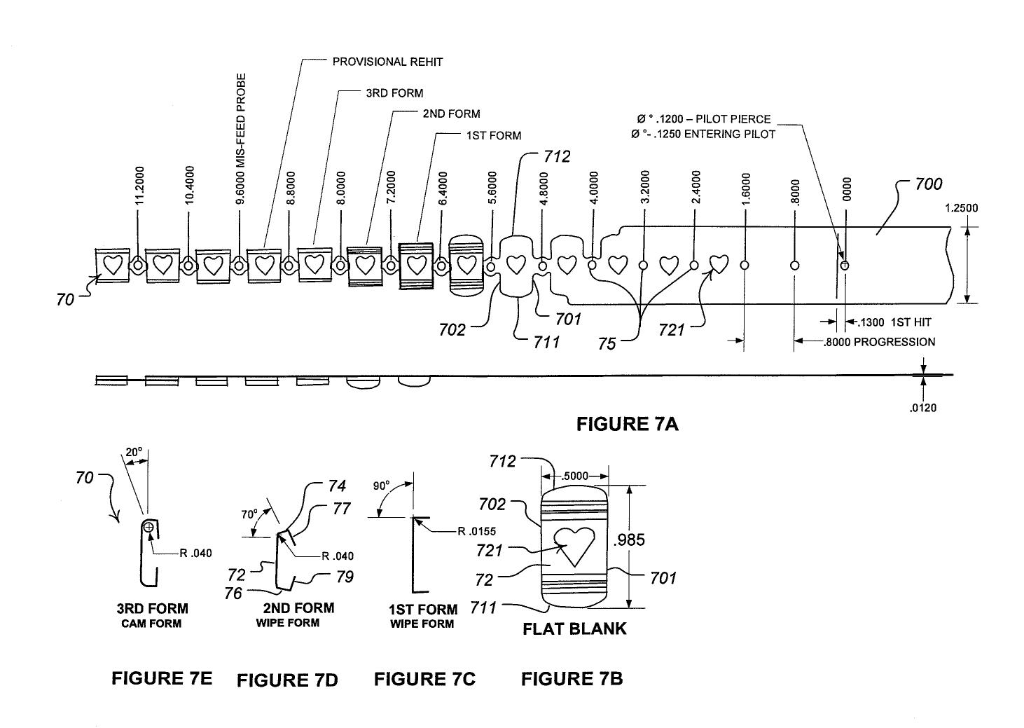

FIGS. 7A-E are schematics describing a progressive stamping manufacturing method, which may be used to manufacture display marker bands of the present invention, and wherein steps, or stages, for manufacturing a plurality of exemplary marker bands 70 are illustrated. It should be noted that embodiments of the present invention are not limited by the dimensions presented in FIGS. 7A-E. According to some methods, a blank or sheet metal strip 700 is loaded into a progressive stamping press which forms, out of strip 700, in sequence, a mark 721, then perimeter edges 701, 702, 711, 712, and then end sidewalls 74, 76 and flap sidewalls 77, 79 for each of the plurality of marker bands 70, one by one. FIG. 7 illustrates sheet metal strip 700 including a plurality of marker bands 70, each of the plurality being at different stage of the forming process, which progresses from right to left. With each complete stroke of the press, each forming die is opened and shut; the strip advances to the next stage when the dies open. Because, with each advance, the strip must be precisely positioned, pilot holes 75 are formed in one of the initial stages of the operation. At each stage, material is either removed from the strip, initial stages, or the material of the strip is formed into sidewalls of the marker bands, whose profiles are shown, generally below the corresponding forming stage in FIGS. 7C-E. Those skilled in the art are familiar with progressive stamping and, in conjunction with FIG. 7A-E, will appreciate details of the method for forming marker bands of the present invention.

With reference back to FIG. 4, an additional forming step may be added following the sidewall forming steps, either integrated into or separate from the progressive stamping process, to form the curved contour of marker band 30′, for example, to match the relaxed contour of flexible closed-loop member 200 to which the marker band will be subsequently attached. Additional alternate processes may end at any of the stages illustrated by FIGS. 7B-E in order to manufacture alternate embodiments of marker band 70. For example, marker band 50, shown in FIGS. 5A-B, may be formed by ending processing at a stage that generally corresponds to the stage illustrated in FIG. 7D. Furthermore, to manufacture marker band 60, shown in FIGS. 6A-B, each sidewall forming stage of the illustrated process may be modified to only form one end sidewall and one flap sidewall, thus leaving a deformable sidewall approximately coplanar with the display sidewall.

Although FIG. 7A illustrates marks 721 being formed as punched apertures in each display sidewall 72 by an initial step in the progressive stamping process, it should be noted that, according to alternate embodiments, marks 721 may be laser cut or etched at a separate station, prior to loading sheet metal strip 700 into a progressive stamping press to form the sidewalls. Alternately, the marks may be formed at a separate station following the progressive stamping. According to further alternate embodiments the marker bands may be individually formed from “cut-to-size” blanks, rather than from a continuous sheet metal strip. According to some embodiments, secondary processes may be carried out following the stamping process. These secondary processes include, without limitation, de-burring and/or removing sharp edges, for example, via tumbling, modifying a color and/or finish of any, or all of the marker band sidewalls via any surface treatment method known to those skilled in the art, and adding a layer of another material to any or all of the marker band sidewalls, for example, via plating, coating, over-molding, or any combination thereof.

In the foregoing detailed description, the invention has been described with reference to specific embodiments. However, it may be appreciated that various modifications and changes can be made without departing from the scope of the invention as set forth in the appended claims.

I claim:

1. A display marker band for reversible attachment to a relatively flexible closed-loop member, the loop member having an approximately rectangular cross-section defined by a relaxed width and a relaxed thickness, the member being adapted to slide over an appendage of a body for mounting thereon, and the marker band comprising:
a first perimeter edge and a second perimeter edge, the second perimeter edge opposing the first perimeter edge;
a rigid display sidewall being bounded by the first and second perimeter edges, the display sidewall including a mark formed therein, an exterior face, along which the mark is displayed, and an interior face opposite the exterior face;
a first rigid end sidewall and a second rigid end sidewall, the second end sidewall opposing the first end sidewall, the first and second end sidewalls being bounded by the first and second perimeter edges and extending from the display sidewall, approximately perpendicular thereto and in relatively rigid relation thereto, such that a distance between the first and second end sidewalls spans the relaxed width of the loop member when the marker band is attached thereto;
a first rigid flap sidewall extending from the first end sidewall and in relatively rigid relation thereto, the first flap sidewall being bounded by a first convexly curved perimeter edge; and
a second rigid flap sidewall extending from the second end sidewall and in relatively rigid relation thereto, the second flap sidewall being bounded by a second convexly curved perimeter edge;
wherein the first and second flap sidewalls are located opposite the interior face of the display sidewall;
the first curved perimeter edge opposes the second curved perimeter edge;
each of the first and second curved perimeter edges are defined by an arc extending from the first perimeter edge to the second perimeter edge; and
an apex of each arc is approximately centered between the first and second perimeter edges and spaced apart from one another by a gap.

2. The marker band of claim 1, wherein the mark is displayed along the exterior face of the display sidewall such that an axis defining an upright orientation of the mark is aligned approximately parallel with an extent of the first and second perimeter edges.

3. The marker band of claim 1, wherein a contour of the display sidewall is relatively flat.

4. The marker band of claim 1, wherein a contour of the display sidewall is curved.

5. The marker band of claim 1, wherein the mark comprises at least one of: a symbol, a number and a word.

6. The marker band of claim 1, wherein the mark is formed by an aperture extending through the display sidewall.

7. The marker band of claim 1, wherein the first and second end sidewalls each have a height extending between the display sidewall and the first and second flap sidewalls, respectively, the height being approximately equal to the relaxed thickness of the loop member.

8. The marker band of claim 1, wherein the gap between the apex of the arc defining the first curved perimeter edge and the apex of the arc defining the second curved perimeter edge is less than or approximately equal to the relaxed thickness of the relatively flexible closed-loop member.

9. The marker band of claim 1, wherein the gap between the apex of the arc defining the first curved perimeter edge and the apex of the arc defining the second curved perimeter edge is greater than the relaxed thickness of the relatively flexible closed-loop member.

10. The marker band of claim 1, wherein the first and second flap sidewalls extend approximately parallel with the display sidewall.

11. The marker band of claim 1, wherein the first and second flap sidewalls are approximately coplanar with one another.

12. The marker band of claim 1, wherein the first and second flap sidewalls extend at an acute angle with respect to the display sidewall.

13. A display marker band for reversible attachment to a relatively flexible closed-loop member, the member having an approximately rectangular cross-section defined by a relaxed width and a relaxed thickness, the member being adapted to slide over an appendage of a body for mounting thereon, and the marker band comprising:
a first perimeter edge and a second perimeter edge, the second perimeter edge opposing the first perimeter edge;
a rigid display sidewall being bounded by the first and second perimeter edges, the display sidewall including a mark formed therein, an exterior face, along which the mark is displayed, and an interior face opposite the exterior face;
an end sidewall extending from the display sidewall, approximately perpendicular thereto and in relatively rigid relation thereto, the end sidewall being bounded by the first and second perimeter edges;
a flap sidewall extending from the first end sidewall, approximately perpendicular thereto and in relatively rigid relation thereto, the flap sidewall being bounded by a first convexly curved perimeter edge and being located opposite the display sidewall; and
a deformable sidewall extending from the display sidewall, approximately parallel thereto, the deformable sidewall being bounded by the first and second perimeter edges and by a second convexly curved perimeter edge;
wherein each of the first and second curved perimeter edges is defined by an arc extending from the first perimeter edge to the second perimeter edge; and
an apex of each arc is approximately centered between the first and second perimeter edges; and
the deformable sidewall is adapted to be bent around the relaxed thickness of the loop member in order to reversibly attach the marker band thereto.

14. The marker band of claim 13, wherein the deformable sidewall includes an interior face being approximately coplanar with the interior face of the display sidewall, a first notch and a second notch, each of the first and second notches being formed in the interior face of the deformable sidewall and extending across the deformable sidewall from the first perimeter edge to the second perimeter edge, the first and second notches being spaced apart from one another.

15. The marker band of claim 13, wherein the mark comprises at least one of: a symbol, a number and a word.

16. The marker band of claim 13, wherein the mark is formed by an aperture extending through the display sidewall.

17. The marker band of claim 13, wherein the mark is displayed along the exterior face of the display sidewall such that an axis defining an upright orientation of the mark is aligned approximately parallel with an extent of the first and second perimeter edges.

18. A method for marking a relatively flexible closed-loop member, the member having an approximately rectangular cross-section and being adapted to slide over an appendage of a body for mounting thereon, the method comprising:
orienting a display marker band such that an exterior face of a display sidewall of the marker band faces away from the relatively flexible closed-loop member, the marker band including a pair of flap sidewalls that extend opposite the display sidewall such that the exterior face of the display sidewall faces away from the flap sidewalls, each of the flap sidewalls being bounded by a convexly curved perimeter edge;
deforming a portion of the relatively flexible closed-loop member; and
inserting the deformed portion of the relatively flexible closed-loop member into a gap between the convexly curved perimeter edges of the flap sidewalls of the marker band, in order to position the member between the display sidewall and the pair of flap sidewalls without deforming the marker band.

19. The method of claim 18, wherein deforming the portion of the flexible closed-loop member comprises twisting the portion of the member.

20. The method of claim 18, wherein deforming the portion of the flexible closed-loop member comprises stretching the portion of the member.

21. The method of claim 18, wherein the flexible closed-loop member is a wrist bracelet.

22. The method of claim 18, further comprising bending at least one of the flap sidewalls toward an inner surface of the inserted flexible closed-loop member after positioning the member between the display sidewall and the pair of flap sidewalls.

23. A method for reversibly marking a relatively flexible closed-loop member, the loop member having an approximately rectangular cross-section defined by a relaxed width, extending between a first edge and a second edge thereof, and a relaxed thickness, the loop member being adapted to slide over an appendage of a body for mounting thereon, and the method comprising:
orienting a display marker band such that an exterior face of a display sidewall of the marker band faces away from the relatively flexible closed-loop member and a flap sidewall of the marker band, which extends opposite the display sidewall, is directed toward the member;
sliding the first edge of the member between the flap sidewall and the display sidewall; and
bending a deformable sidewall of the marker band about the second edge of the member, such that the deformable sidewall bends around the relaxed thickness of the loop member.

24. The method of claim 23, further comprising removing the marker band from the relatively flexible closed-loop member by deforming a portion of the loop member and inserting the deformed portion into a gap between the flap sidewall and the bent deformable sidewall, without deforming the marker band.

25. The method of claim 24, wherein deforming the portion of the loop member comprises at least one of: twisting and stretching the portion of the member.

26. The method of claim 20, wherein the member is one of: a shoe strap, a finger ring, a wrist bracelet and an ankle bracelet.
